(19) United States
(12) Patent Application Publication
(10) Pub. No.: US 2001/0016473 A1
(43) Pub. Date: Aug. 23, 2001

(54) Combination

(75) Inventors: Ralf Gester, Dusseldorf (DE); Markus Thrien, Gelsenkirchen (DE)

Correspondence Address: Clarence A. Green, PERMAN & GREEN, LLP, 425 Post Road, Fairfield, CT, 06430, US

(73) Assignee: Nokia Mobile Phones Ltd.

(21) Appl. No.: 09/749,316

(22) Filed: Dec. 27, 2000

(30) Foreign Application Priority Data
Dec. 28, 1999 (DE) 19963379.7

(51) Int. Cl. H04B 1/38

(52) U.S. Cl. 455/90; 455/575; 455/550

(57) ABSTRACT

The invention relates to the design of a combination consisting of a telephone 10 and a holder 14, in particular with the type and manner of the connection between the telephone 10 and holder.

To accomplish this it is specified that there is a tongue 13 of width B2 and a slot 15 that is complementary to the tongue 13 where the width B2 of the tongue 13 is smaller than the width B1 of the telephone 10, and that the tongue 13 engages the slot 15 solely for the purpose of securing the telephone 10 in the holder 14. This avoids the common enlargements usually required to secure the telephone 10 that extend into the clearance area of the telephone 10. In addition, the invention has the advantage that at least the contacts 16 of the telephone 10 can easily be placed in a covered location when the telephone 10 and holder 14 are connected in accordance with the invention.

### FIELD OF THE INVENTION

The invention relates to the design of a combination of a telephone and a holder, in particular with the type and manner of connection between the telephone and holder.

### BACKGROUND OF THE INVENTION

According to the background of the invention, it is known that mobile telephones or cordless telephones are joined to a holder for safekeeping or to load the battery pack. To fulfill this purpose, the known holders are generally equipped with a cavity in which the corresponding telephone is placed for safekeeping or to load it. If the corresponding telephone is operated as a car telephone, for example, then additional safety measures are required to prevent a car telephone located in the holder from being thrown out of the holder during an accident and possibly injuring passengers. Examples of known safety measures are snap-hook connections that snap into place behind corresponding tabs when the telephone is connected to the holder. Due to the fact that car telephones are often commercial mobile telephones and therefore do not have any special features in spite of the ability to use them in a vehicle, the securing mechanism that holds the mobile telephone in place in or on the holder is only formed on or inside the holder. Refer to DE-A-1 99 34 099 for examples of such mechanisms.

As can easily be realized, the integration of the corresponding securing mechanisms on or in the holders results in a requirement for additional space for the holders that exceeds the clearance provided for the mobile telephones, which increasingly leads to problems in the automobile industry as the purchaser of such holders.

For this reason the invention is the result of the task of specifying a holder for telephones that guarantees the “crash-safe” connection between the holder and telephone that does not require more space than the space provided by the clearance of the corresponding telephone.

### SUMMARY OF THE INVENTION

This task will be accomplished using the features specified in claim 1. Advantageous extensions and expansions of the invention can be obtained in claims 2 through 8.

If in accordance with claim 1 the width B2 of the tongue and its complementary slot is less than the width of the telephone, then it is possible to secure the telephone solely on the back of the telephone. Whether the tongue is formed on the telephone and the slot on the holder or the telephone is equipped with the slot and the holder with the tongue is of secondary importance to the securing function, although each of the two designs has its own advantages. If the telephone is equipped with the tongue, then the holder can be designed without any protruding parts. To be more precise, in this case it is sufficient just to provide a slot in a housing wall at the location where the telephone is secured, for example, in which the tongue of the telephone extends to secure the telephone. In addition, the tongue formed on the telephone can be used as a clip to secure the telephone on clothes, for example.

The telephone is secured in a “crash-safe” manner when in accordance with claim 2 there is a securing mechanism on the tongue and/or on the slot that provides protection against the accidental separation of the tongue and slot when the tongue is inserted in the slot and when there is a release mechanism present that acts on the securing mechanism that in the activated state allows the slot 15 and tongue 13 to be separated from each other.

If in accordance with claim 3 the release mechanism is part of the telephone, then the telephone is especially easy to separate from the holder.

If in accordance with claim 4 there are electrically conducting contacts on the tongue and in the slot that are in physical contact with each other when the tongue and slot are connected to each other, then exposed contacts can be avoided at least on the telephone without introducing any additional complexity. In particular, this prevents the occurrence of an accidental, faulty contact due to a conductive object (such as a coin or a key) when the mobile telephone is carried in a pocket in clothing, for example.

If in accordance with claim 5 the tongue essentially has two long sides and four short sides, and if the contacts formed on the tongue are located only on one of the two long sides, then the other long side of the tongue at least protects the contacts located on the tongue from coming into physical contact with objects and/or prevents faulty contacts.

Complete protection from physical contact with the contacts and/or faulty contact of the contacts is provided when in accordance with claim 6 the contacts on the tongue and/or in the slot are equipped with a movable shield that only exposes the correspondingly shielded contacts after the tongue is inserted in the slot.

If in accordance with claim 7 the telephone is equipped with the slot and the holder is equipped with the tongue, then no special modifications must be made on the telephone.

In particular, the design of the contacts and the required complexity of the design of the contacts is significantly reduced when done as specified in claim 7. Specifically, if in accordance with claim 8 there is a main circuit board inside the telephone, then the contacts that come into physical contact with the contacts of the tongue when the tongue is inserted in the slot can be formed on the main circuit board in a very simple manner.

### BRIEF DESCRIPTION OF THE DRAWINGS

The following figures contain the following:

FIG. 1 Side view (schematic) of a telephone and a holder;

FIG. 2 Rear view a telephone according to FIG. 1:

FIG. 3 Another side view (schematic) diagram of a telephone and a holder;

FIG. 4 Another side view (schematic) diagram of a telephone and a holder;

FIG. 5 Another design of a telephone and a holder according to FIG. 4;

FIG. 6 A perspective view of a telephone and a holder;

FIG. 7 An exploded drawing of a telephone according to FIG. 6;

FIG. 8 A release mechanism with a holder; and

FIG. 9 Another diagram according to FIG. 8.

### DETAILED DESCRIPTION OF THE PREFERRED EMBODIMENTS OF THE INVENTION

The invention will now be explained in more detail based on the figures.

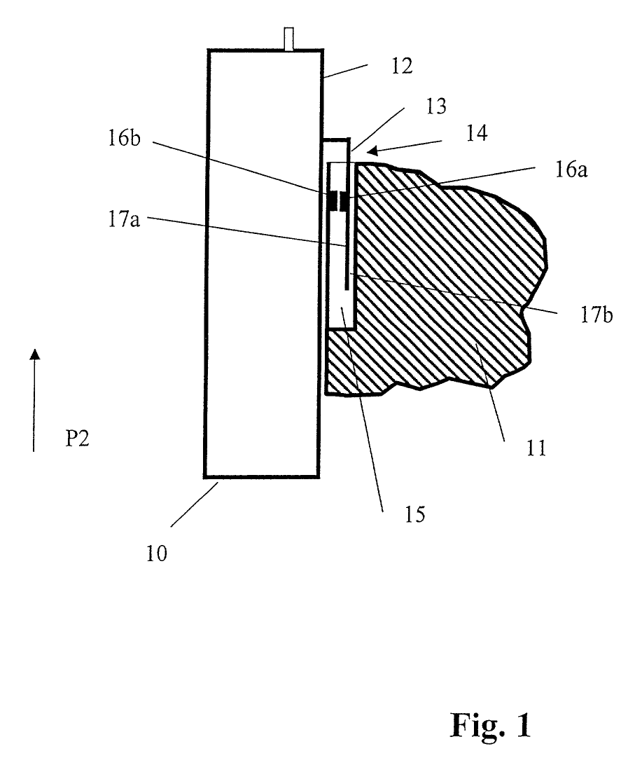

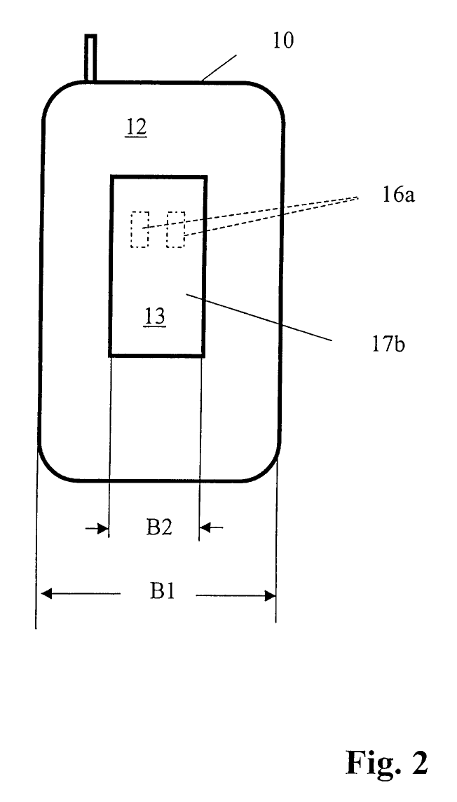

FIG. 1 shows a telephone 10 in the form of a mobile telephone that is detachably connected to a housing shell 11. For this purpose the rear 12 of the telephone 10 is equipped with a tongue 13. The holder 14 in this diagram is essentially formed by a slot 15 in the housing shell 11 that is complementary to the tongue 13. In addition there are electrically conductive contacts 16a and 16b on the tongue 13 and inside the slot 15 that are in physical contact with each other when the tongue 13 has reached its end position in the slot 15. The contacts 16a and 16b are not shown to be in physical contact with each other in FIG. 1 although the tongue 13 has reached its end position in the slot 15 solely for the purpose of improving the illustration of the relationship between the parts. It can also be seen in FIG. 1 that the contacts 16a are only formed on the long side 17a of the tongue 13 that faces the rear 12 of the telephone 10. This provides a form of shock protection as the contacts 16a are covered by the other long side 17b when the telephone is removed from the holder 14 (see also FIG. 2).

We would like to point out at this point that the contacts 16a and 16b are unnecessary in all designs discussed here when the telephone 10 does not require a conductive connection to other components such as those integrated in the housing shell 11, for example.

If the telephone 10 is to be separated from the housing shell 11, then, based on the position shown in FIG. 1, the telephone 10 only needs to be moved upwards in the direction of the arrow P1 until the tongue 13 has been entirely pulled out of the slot 15. Once this state is reached, the tongue 13 can be used together with the rear 12 of the telephone 10 to secure the telephone 10 on the clothes of the user, for example. In addition it is obvious that when the telephone 10 is separated from the housing shell 11, there are no protruding edges or corners. This is advantageous especially when the housing shell 11 is formed by the dashboard of a vehicle, for example.

FIG. 2 shows the rear view of the telephone 10 according to FIG. 1. It can clearly be seen in this diagram that the width B2 of the tongue 13 is smaller than the width B1 of the telephone 10. The result of this design is that no part of the tongue 13 and slot 15 is visible when the telephone 10 is connected to the housing shell 11 or to the slot 15 in the housing shell 11 as shown in FIG. 1.

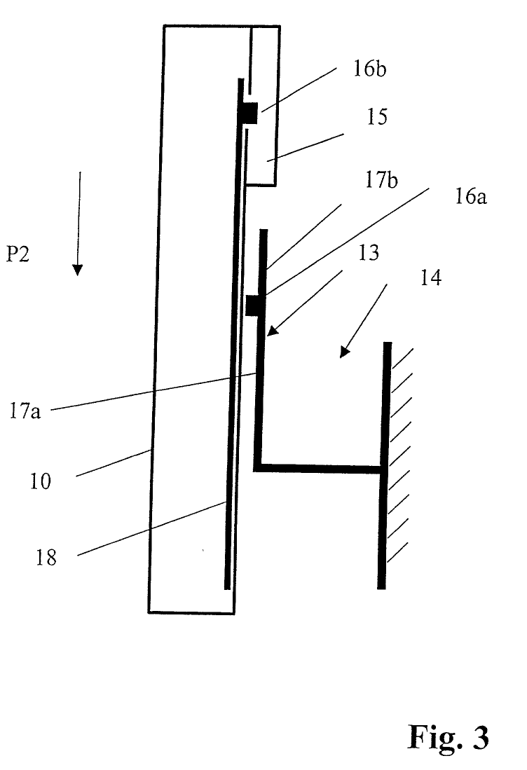

FIG. 3 also shows the side view of a telephone 10 and a holder 14, although the telephone 10 is not yet connected to the holder 14. In contrast to the previously discussed designs, the telephone 10 in FIG. 3 is equipped with the slot 15, while the tongue 13 is formed on the holder 14. If the telephone 10 is now moved downwards in the direction of the arrow P2, then the tongue 13 enters the slot 15. Once the tongue 13 has reached its end position in the slot 15, the electrically conductive contacts 16a and 16b are in physical contact with each other. Even though the telephone 10 in FIG. 3 is only shown schematically, it can still be seen in this diagram that the telephone 10 is equipped with a main circuit board 18 on which the majority of the components (not shown) required for the telephone 10 are located. It can also be seen that the contacts 16b of the telephone 10 are located directly on the main circuit board 18. The result of this design is that the contacts 16b can be especially easy and inexpensively formed on the telephone 10 when a conductive connection between the telephone 10 and the holder 14 is required.

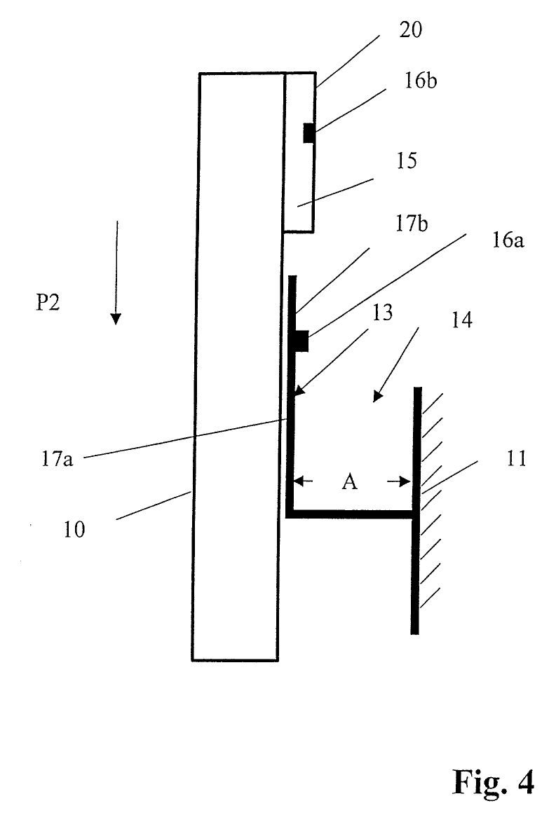

The design shown in FIG. 4 differs from the design according to FIG. 3 in that the contacts 16a on the tongue 13 are not located on the long side 17a facing the telephone 10, but on the long side 17b facing away from the telephone 10 instead. The result of locating the contacts 16a as shown in FIG. 4 is that the contacts 16b on the telephone 10 do not have to be formed on the main circuit board 18 as shown in FIG. 3, but on the wall of the slot 20. However, the fact that the contacts 16a are located on the long side 17b the tongue 13 results in a very simple implementation of a form of shock protection when, in contrast to the diagram according to FIG. 4, the distance A between the tongue 13 and the housing shell 11 is further reduced.

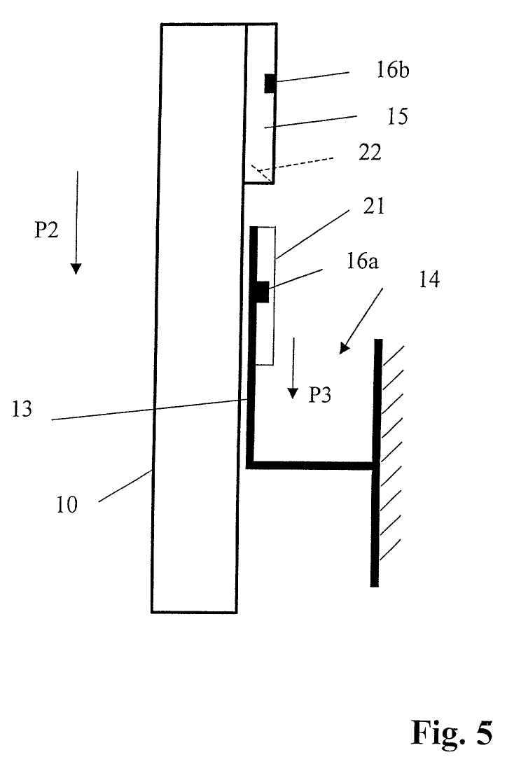

The distance shown in FIG. 4 does not have to be reduced to implement shock protection when in accordance with FIG. 5 the contacts 16a are protected by a movable slider 21 that slides on the tongue 13 in the direction of the arrow P3 and exposes the contacts 16a when the telephone 10 or the slot 15 is pushed in the direction of the arrow P2 onto the tongue 13. If the slot 15 is also to be protected, then this can be accomplished with a movable cover 22 (shown by the dotted line in FIG. 5) that opens when the tongue 13 is inserted in the slot 15.

Just for the sake of completeness we would like to point out that the protective mechanisms formed by the cover 22 and/or the slider 21 are not limited to the design shown in FIG. 5, but can also be implemented in all other designs presented in this application by expanding on the designs.

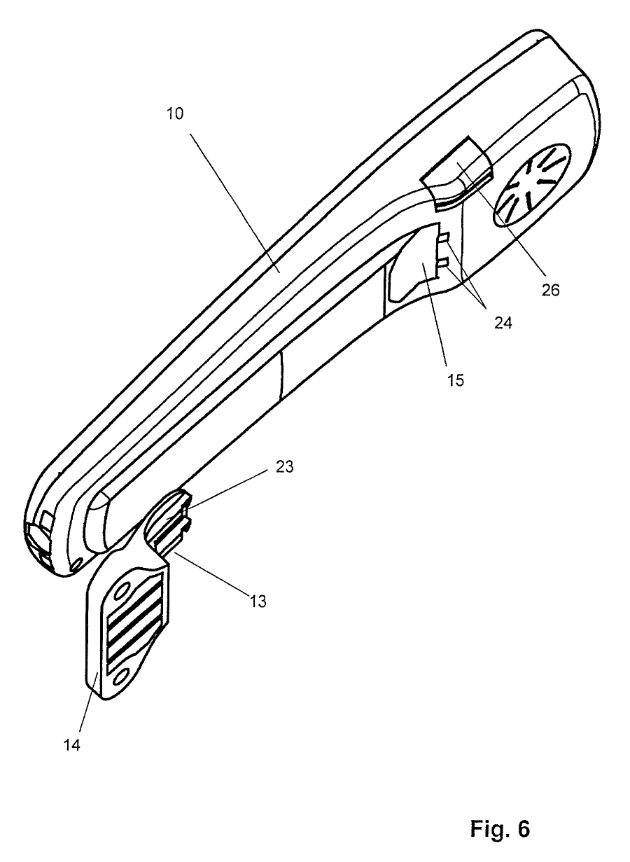

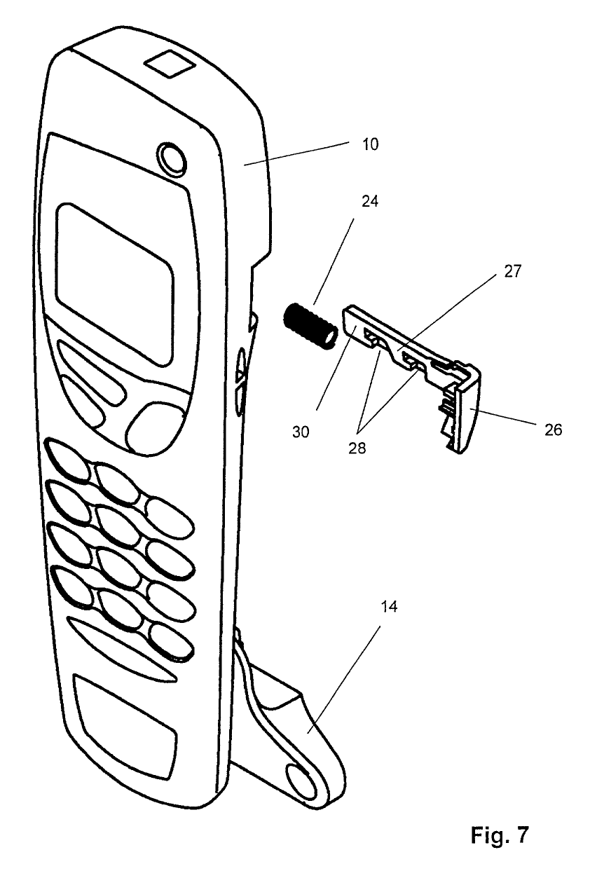

The perspective view shown in FIG. 6 shows a telephone 10 and a holder 14 of the type already explained in the context of FIGS. 3 and 4. To make inserting the tongue 13 in the slot 15 easier, there are tabs 23 on the long side 17b of the tongue 13 that engage the complementary guides 24 on the slot 15 when the tongue 13 is inserted in the slot 15. In addition, FIG. 6 shows a push button 26 on the telephone 10 that acts as a release mechanism that will be explained in more detail in the context of FIGS. 7 through 9.

This push button 26, as shown in FIG. 7, is connected to a sliding clip 27 and is inserted in the telephone 10 (the latter is not shown). There are locking hooks 28 formed on the sliding clip 27 to provide a secure connection between the telephone 10 and the holder 14 when the tongue 13 is inserted in the slot 15. In addition there is a spring 29 that acts on the sliding clip 27 that, when the push button 26 is pushed into the telephone 10, always returns the push button 26 and the sliding clip 27 connected to it back to the starting position shown in FIG. 6.

Just for the sake of completeness we would like to note that the surface 30 of the sliding clip 27 can also be equipped with contacts when an electrically conductive connection is desired between the telephone 10 and the holder 14 (not shown separately in FIG. 7).

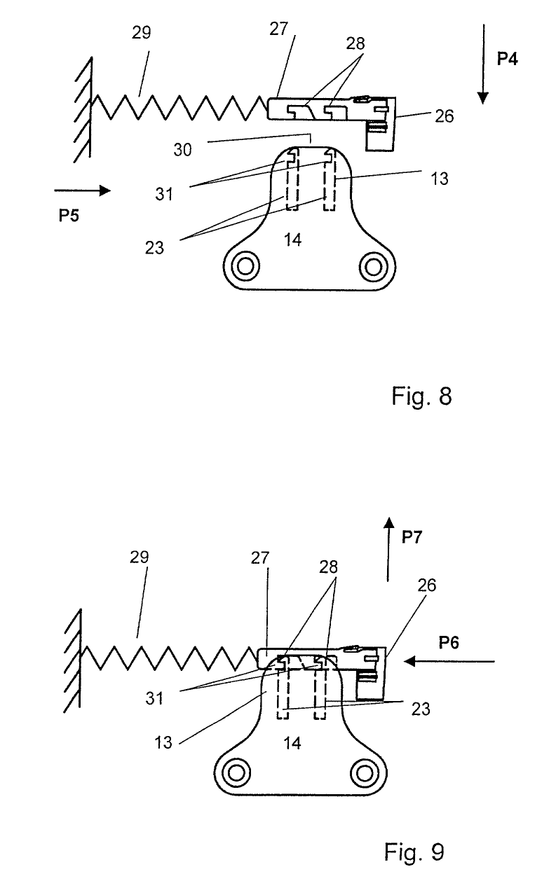

Only the holder 14, the push button 26 with the sliding clip 27 and the spring 29 are shown in FIGS. 8 and 9 to improve the clarity of the illustration of the relationship between the telephone and holder 14 when securing the telephone. In addition, the diagrams shown in FIGS. 8 and 9 clearly show that there are two tabs 23 formed on the long side 17b of the tongue 13 facing away from the viewer when the viewer is looking at the figures. Each of these tabs 23 is equipped with a hook 31 on the upper end near the free end 30 of the tongue 13.

FIG. 8 indicates by the distance between the holder 14 and the sliding clip 27 that the tongue 13 is not yet completely inserted in the slot 15 (not shown in FIG. 8). If the sliding clip 27 is now moved in the direction of the arrow P4 onto the tongue 13 to connect the telephone 10 to the holder 14, the hooks 31 come into physical contact with the locking hooks 28 on the sliding clip 27 and move the sliding clip 27 in the opposite direction of the arrow P5 immediately before the tongue 13 reaches its end position in the slot 15. This loads the spring 29 slightly so that when the tongue 13 has reached its end position in the slot 15 the sliding clip 27 is moved in the direction of the arrow P5 by the spring 29 back to its start position, whereby the locking hooks 28 simultaneously snap into place on the hooks 31. The interaction between the hooks 31 and locking hooks 28 is illustrated in more detail in FIG. 9. If the telephone and the holder 14 shown in FIG. 9 are to be disconnected from each other, the push button 26 only has to be pressed in the direction of the arrow P6. The locking hooks 28 on the sliding clip 27 release the hook 31 on the tongue 13 through this movement so that the sliding clip 27 can then be separated from the tongue 13 by a movement in the direction of the arrow P7, which is synonymous with removing the telephone from the holder 14. As the spring 29 is slightly compressed by the movement of the sliding clip 27 in the direction P6, the push button 26 is returned to its starting position along with the sliding clip 27 when no more force is applied in the direction P6.

1. Combination consisting of
a telephone 10 of width B1 and
a holder 14 where the holder 14 holds the telephone 10 at least some of the time,
characterized in that
there is a tongue 13 with a slot 15 of width B2 that is complementary to the tongue 13 where the width B2 is smaller than the width B1 and
the tongue 13 engages the slot 14 solely to secure the telephone 10 in the holder.

2. Combination according to claim 1
characterized in that
there is a securing mechanism 28, 31 on the tongue 13 and/or slot 15 that protects against accidental separation of the tongue 13 and slot 15 when the tongue 13 is inserted in the slot 15 and
there is a release mechanism 26, 27 that interacts with the securing mechanism 28, 31 that in the activated state allows the slot 15 and tongue 13 to be separated from each other.

3. Combination according to claim 2
characterized in that
the release mechanism 26, 27 is part of the telephone 10.

4. Combination according to one of claims 1, 2 or 3
characterized in that
there are electrically conductive contacts 16a, 16b on the tongue 13 and in the slot 15 that are in physical contact with each other when the tongue 13 and slot 15 are connected to each other.

5. Combination according to claim 4
characterized in that
the tongue 13 essentially has two long sides 17a, 17b and four short sides and the contacts 16a formed on the tongue 13 are only located on one of the two long sides 17a or 17b.

6. Combination according to claim 4 or claim 5
characterized in that
the contacts 16a, 16b on the tongue 13 and/or in the slot 15 are equipped with a movable shield 21, 22 that exposes each of the shielded contacts 16a, 16b only after the tongue 13 is inserted in the slot 15.

7. Combination according to one of claims 1 through 6
characterized in that
the tongue 13 is formed on the holder 14, and the slot 15 is formed on the telephone 10.

8. Combination according to claim 6
characterized in that
there is a main circuit board 18 inside the telephone 10 and
each of the electrically conductive contacts 16b of the telephone 10 are formed directly on the main circuit board 18.
